(19) United States
(12) Patent Application Publication
(10) Pub. No.: US 2006/0136941 A1
(43) Pub. Date: Jun. 22, 2006

(54) Disc changer and tray locking apparatus thereof

(75) Inventor: Tsung-Jung Kuo, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Lite-On It Corporation

(21) Appl. No.: 11/268,889

(22) Filed: Nov. 8, 2005

(30) Foreign Application Priority Data
Dec. 17, 2004 (TW) 093139371

(51) Int. Cl. G11B 17/04; G11B 33/02; G11B 17/03

(52) U.S. Cl. 720/610

(57) ABSTRACT

A tray locking apparatus for a disc changer is provided. The disc changer has a plurality of trays, and each tray is selectively disposed as a storing zone and a reproducing zone. The tray locking apparatus includes a drawing device, a locking member, and a releasing member. The drawing device is moveably installed in the reproducing zone for drawing a selected tray among the trays form the storing zone to the reproducing zone. The locking member has a plurality of locking feet, and each locking foot respectively engages with one of the trays. The releasing member is disposed on the drawing device and has a protrusion biasing the locking foot engaging with the selected tray to be disengaged from the selected tray. Thus, the motion of each tray is efficiently restricted for preventing an unselected tray from sliding out of the storing zone under the unexpected vibrations and impacts.

### BACKGROUND OF THE INVENTION

1. Field of the Invention

The present invention relates to a disc changer, in particular, to a disc changer with a tray locking apparatus which locks and releases trays individually.

2. Description of the Related Art

In the traditional disc changer, a magazine stocking a plurality of trays is removably installed in the disc changer for the user changing the discs placed on the trays. Besides, the disc changer further has a drawing apparatus and a recording/reproducing apparatus. The drawing apparatus is used to draw a selected tray among the trays from the magazine to a reproducing position for the recording/reproducing apparatus recording or reproducing the data on a disc which is placed on the selected tray.

Each tray is slideably disposed in the magazine for being drawn out of the magazine by the user to place the disc on the tray or by the drawing apparatus to draw the tray to the reproducing place. However, the trays may slide out of the magazine under an unexpected vibration or impact, and the trays sliding out of the magazine will cause the interference between the mechanisms inside the disc changer and result in the break of the mechanisms inside the disc changer. Specially, the disc changer is generally installed in the car wherein the unexpected vibrations and impacts are happened all the time when the car is running, so that the trays may easily slide out of the magazine without expectation and cause the damage of the mechanisms inside the disc changer.

Therefore, there should be an apparatus for preventing the trays from sliding out of the magazine unexpectedly to avoid influencing the motion of the mechanisms inside the disc changer and causing the damage of the mechanisms.

### SUMMARY OF THE INVENTION

Accordingly, at least one object of this application is to provide a tray locking apparatus for the disc changer, wherein the motion of each tray is efficiently restricted for preventing an unselected tray from sliding out of the storing zone under the unexpected vibrations and impacts.

To achieve these and other advantages and in accordance with the purpose of the invention, as embodied and broadly described herein, the invention provides a tray locking apparatus disposed in a disc changer. The disc changer has a plurality of trays, and each tray is selectively disposed as a storing zone and a reproducing zone. The tray locking apparatus includes a drawing device, a locking member, and a releasing member.

The drawing device is moveably installed in the reproducing zone for drawing a selected tray among the trays form the storing zone to the reproducing zone. The locking member has a plurality of locking feet, and each locking foot respectively engages with one of the trays. The releasing member is disposed on the drawing device and has a protrusion biasing the locking foot engaging with the selected tray to be disengaged from the selected tray.

The present invention also provides a disc changer including a housing, a magazine, a plurality of trays, a drawing device, a locking member, and a releasing member. The housing is divided into a storing zone and a reproducing zone. The magazine is disposed in the storing zone of the housing for stacking the trays. The drawing device is moveably installed in the reproducing zone for drawing a selected tray among the trays from the storing zone to the reproducing zone. The locking member is disposed on the housing and has a plurality of locking feet each of which respectively engages with one of the trays. The releasing member is disposed on the drawing device and has a protrusion biasing the locking foot engaging with the selected tray to be disengaged from the selected tray.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of the disc changer according to the preferred embodiment of the present invention;

FIG. 2 is a perspective view showing the structure inside the housing of FIG. 1, wherein the drawing device is at the bottom place;

FIG. 3 is a perspective view showing the structure inside the housing of FIG. 1, wherein the drawing device is moved to the top place;

FIG. 4 is a perspective view showing the locking member of the tray locking apparatus according to the preferred embodiment of the present invention;

FIG. 5 is a side view of the locking member of FIG. 4;

FIG. 6 is a top view of the locking member of FIG. 4;

FIG. 7 is a perspective view of the drawing apparatus of FIG. 1;

FIG. 8 is a perspective view showing the structure of the tray of FIG. 2; and

FIG. 9 is a partial enlarged view showing the relation between the tray, the locking member and the releasing member of FIG. 2.

### DESCRIPTION OF THE EMBODYMENTS

The present invention is illustrated in more detail by reference the following preferred embodiments which are only used for illustration without limited the scope of the present invention.

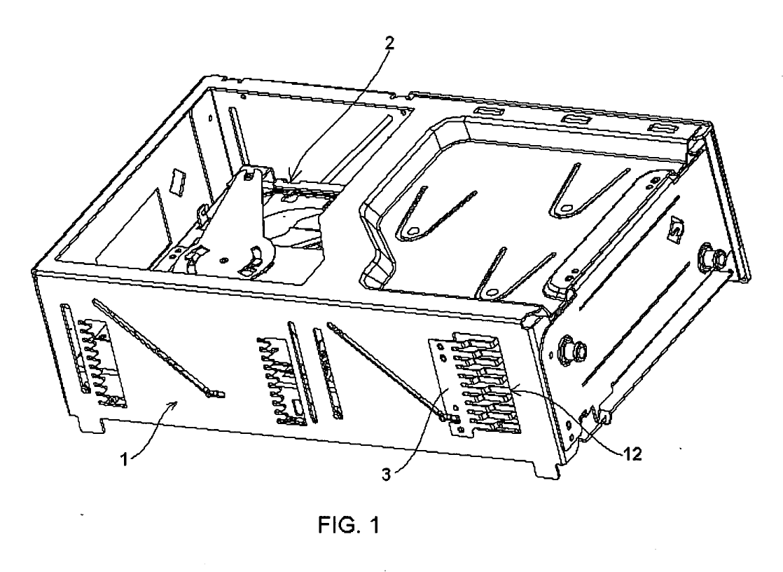

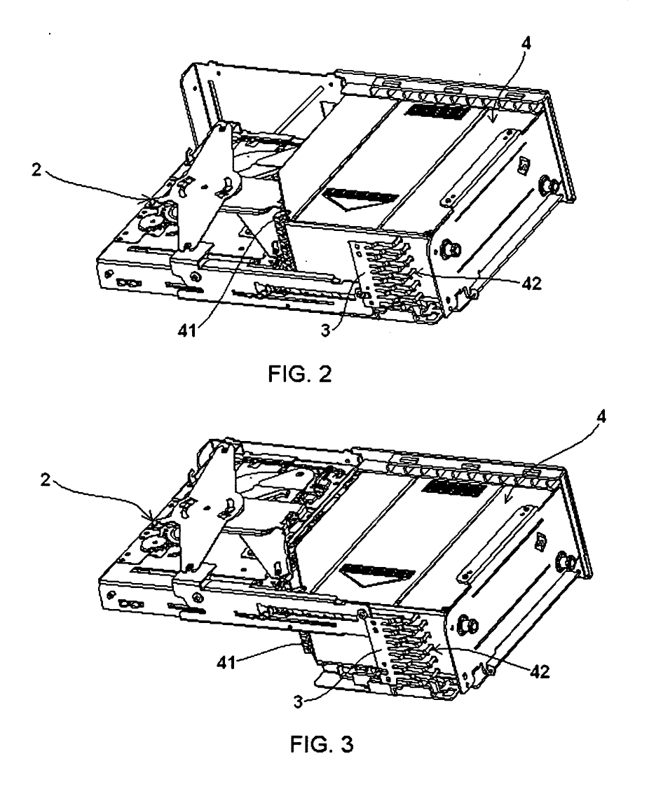

Please refer to FIG. 1 and FIG. 2 which respectively shows a perspective view of the disc changer and the structure inside the housing according to the preferred embodiment of the present invention. The disc changer includes a housing 1, a magazine 4, a plurality of trays 41 and a tray locking apparatus. The tray locking apparatus includes a locking member 3 fixedly disposed on the housing 1 and a drawing device 2. The housing 1 is divided into a storing zone and a reproducing zone, and the magazine 4 is disposed in the storing zone and accommodates a plurality of trays 41. The drawing device 2 is disposed and moved up/down in the reproducing zone for drawing one of the trays 41 from the storing zone to the reproducing zone, which means drawing the tray from the storing position inside the magazine 4 to the reproducing position for reproducing the data of the disc placed on the tray. Besides, the magazine 4 can be taken out from the housing 1 for placing or changing the disc on the tray.

Please refer to FIG. 2 and FIG. 3. FIG. 3 is a perspective view showing the structure inside the housing 1 of FIG. 1, wherein the drawing device 2 is moved to the top place. The drawing device 2 moves up/down in the housing 1 to a position facing a selected tray for drawing the selected tray from the storing zone to the reproducing zone.

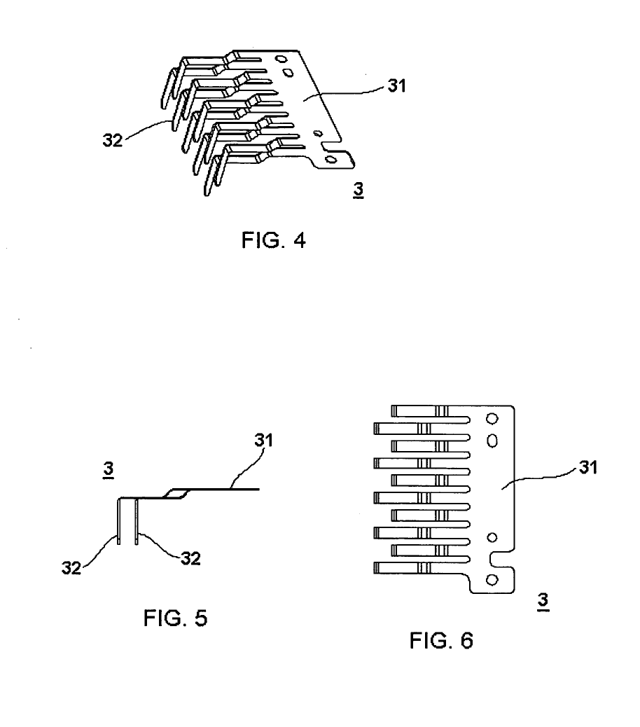

Please refer to FIG. 4 to FIG. 6, which shows a perspective view of the locking member of the tray locking apparatus according to the preferred embodiment of the present invention. The locking member 3 has a fixing portion 31 fixed on the housing 1 and a plurality of locking feet for engaging related trays respectively. There is an opening 12 on the housing 1, seeing the FIG. 1, and a plurality of holes 42 on the magazine 4 related to the locking feet 32, seeing the FIG. 2, therefore, the locking feet 32 are extended through the opening 12 into the inside of the housing 1, and through the related holes 42 to lock the related trays 41 inside the magazine 4.

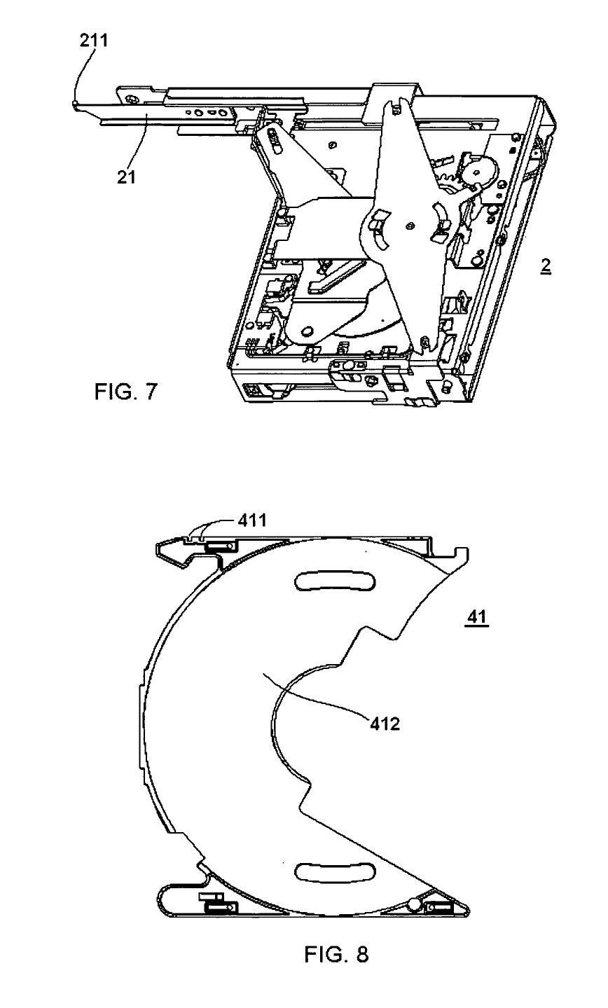

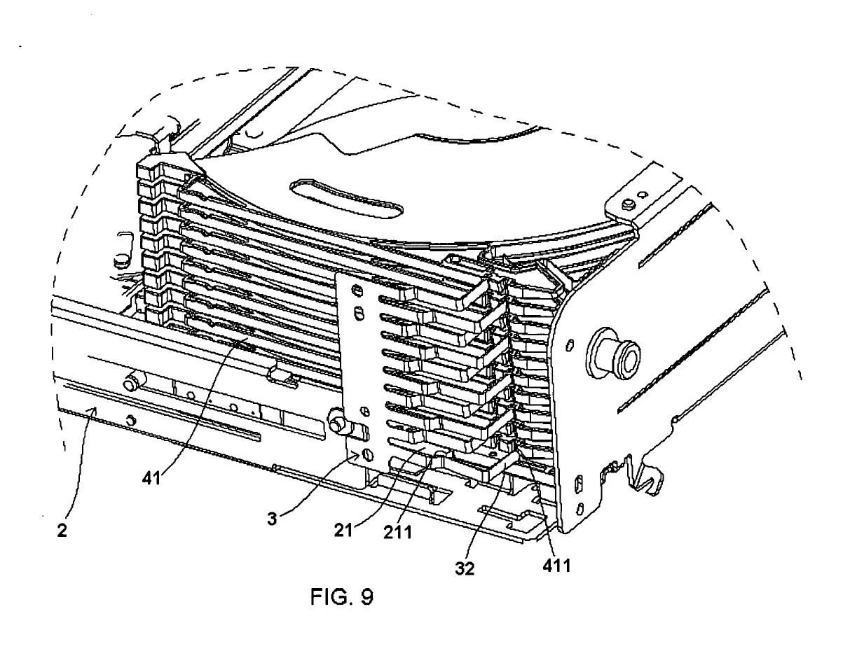

Please refer to FIG. 7 showing a perspective view of the drawing apparatus of FIG. 1. The tray locking apparatus further includes a releasing member 21 disposed on the drawing device 2, and the releasing member 21 has a protrusion 211 for disengaging the locking foot 32 from the selected tray 41 to released the selected tray 41. The releasing member 21 is moved with the drawing device 2, and when the drawing device 2 moves to face the selected tray, the releasing member 21 removes the locking foot engaging with the selected tray, as shown in FIG. 9, for releasing the selected tray so that the drawing device 2 can draw the selected tray from the storing zone to the reproducing zone.

Please refer to FIG. 8, which is a perspective view showing the structure of the tray of FIG. 2. In the preferred embodiment of the present invention, each tray 41 has a disc accommodating portion 412 for placing a disc and a engaged portion 411 for engaging with the related locking foot 32 of the locking element 3 so that each tray 41 can be fixed in the storing zone (magazine 4) by the related locking foot 32, as shown in FIG. 9.

According to the referred embodiment of the present invention, the locking feet 32 of the locking member 3 can lock the trays 41 respectively. When the drawing device 2 draws the selected tray from the storing zone to the reproducing zone, the releasing member 21 disposed on the drawing device 2 only disengages the locking feet which engages on the selected tray for releasing the selected tray only. The other unselected trays are still kept at the locked state. Therefore, during the selected tray being moved from the storing zone to the reproducing zone by the drawing device 2, the other unselected trays will not leave out the storing zone due to the vibrations or impacts to damage the internal mechanism of the disc changer.

While the present invention has been particularly shown and described with reference to exemplary embodiments thereof, it will be understood by those of ordinary skill in the art that various changes and modifications may be made therein without departing from the spirit and scope of the present invention as defined by the following claims.

What is claimed is:

1. A tray locking apparatus for a disc changer having a plurality of trays wherein each of said trays is selectively disposed at a storing zone and a reproducing zone, said apparatus comprising:
a drawing device, moveably installed in said reproducing zone for drawing a selected tray among said trays from said storing zone to said reproducing zone;
a locking member, having a plurality of locking feet each of which respectively engages with one of said trays; and
a releasing member, disposed on said drawing device and having a protrusion biasing said locking foot engaging with said selected tray to be disengaged from said selected tray.

2. The tray locking apparatus according to claim 1, wherein each of said trays has an engaging portion engaging with said locking feet respectively.

3. The tray locking apparatus according to claim 1, wherein said releasing member is moved with said drawing device.

4. A disc changer, comprising:
a housing, having a storing zone and a reproducing zone;
a magazine, disposed in said storing zone of said housing;
a plurality of trays, slideably stacked in said magazine;
a drawing device, moveably installed in said reproducing zone for drawing a selected tray among said trays from said storing zone to said reproducing zone;
a locking member, disposed on said housing and having a plurality of locking feet each of which respectively engages with one of said trays;
a releasing member, disposed on said drawing device and having a protrusion biasing said locking foot engaging with said selected tray to be disengaged from said selected tray.

5. The tray locking apparatus according to claim 4, wherein said magazine is removable disposed in said housing.

6. The tray locking apparatus according to claim 4, wherein said housing has an opening and said feet pass through said opening into the inner of said housing.

7. The tray locking apparatus according to claim 4, wherein said magazine has an opening and said feet pass through said opening into the inner of said magazine for engaging with said trays.

8. The tray locking apparatus according to claim 4, wherein said magazine has a plurality of openings and each of said feet respectively passes through said openings into the inner of said magazine for respectively engaging with said trays.

9. The tray locking apparatus according to claim 4, wherein each of said trays has an engaging portion engaging with said locking feet respectively.

10. The tray locking apparatus according to claim 4, wherein said releasing member is moved with said drawing device.

11. The tray locking apparatus according to claim 4, wherein said locking member has a fixing portion fixed on said housing.
